(19) United States
(12) Patent Application Publication
(10) Pub. No.: US 2026/0283072 A1
(43) Pub. Date: Sep. 24, 2026

(54) CUTTING APPARATUS SUPPORT

(71) Applicant: British American Tobacco (Investments) Limited, London (GB)

(72) Inventors: Jeronimo SCREMIN, Santa Cruz do Sul (BR); Edi MARZARI, Santa Cruz do Sul (BR); Ricardo SCHUTZ, Rio Negro (BR)

(21) Appl. No.: 19/477,042

(22) PCT Filed: Apr. 19, 2024
(86) PCT No.: PCT/EP2024/060807

§ 371 Date: Oct. 20, 2025

(30) Foreign Application Priority Data
Apr. 20, 2023 (BR) 10 2023 007608 4
Apr. 20, 2023 (GB) 2305830.8

(51) Int. Cl. A01D 42/00; A01D 101/00

(52) U.S. Cl. CPC A01D 42/00; A01D 2101/00

(57) ABSTRACT

A cutting apparatus support comprising a mount arranged to mount a plant cutting apparatus. The mount comprises at least two mounting configurations so as to interchangeably mount at least two different sized plant cutting apparatus. The cutting apparatus support further comprises a support structure arranged to support the mount above a plant bed and a movement arrangement configured to allow the support structure to be moved relative to the plant bed.

### CROSS-REFERENCE TO RELATED APPLICATIONS

This present application is a National Phase entry of PCT Application No. PCT/EP2024/060807, filed Apr. 19, 2024, which claims priority from Brazilian Application No. 10 2023 007608 4, filed Apr. 20, 2023, and which claims priority from Great Britain Application No. 2305830.8, filed Apr. 20, 2023, each of which are fully incorporated herein by reference in their entireties.

### TECHNICAL FIELD

The present invention relates to cutting apparatus supports and also to systems comprising a cutting apparatus support and a cutting apparatus supported thereon.

### BACKGROUND

Plants often require pruning in order to regulate their growth. As an example, tobacco seedlings require pruning during their growth in order to achieve an optimal yield. Tobacco plants may be grown in trays which are filled with substrates to support the growth of the tobacco plants. Multiple trays are often arranged to form plant beds. The trays are typically removed from the plant beds in order to prune the plants therein.

### SUMMARY

According to an aspect, there is provided a cutting apparatus support comprising:
a mount arranged to mount a plant cutting apparatus, wherein the mount comprises at least two mounting configurations so as to interchangeably mount at least two different sized plant cutting apparatus;
a support structure arranged to support the mount above a plant bed; and
a movement arrangement configured to allow the support structure to be moved relative to the plant bed.

The mount may adjustable to provide the at least two mounting configurations.

The mount may comprise a plurality of mounting points for mounting the plant cutting apparatus, and wherein a spacing between the mounting points may be adjustable so as to provide the at least two mounting configurations.

The mount may comprise a plurality of mounting points for mounting the plant cutting apparatus, and wherein each of the mounting points comprise at least one aperture shaped to receive a mounting element extending from the plant cutting apparatus.

The plant cutting apparatus may comprise a lawnmower, and the mounting element may be an axle of the lawnmower.

The at least one aperture may comprise an elongate aperture configured to support the mounting element at a plurality of positions along a length of the elongate aperture.

The cutting apparatus may comprise at least one guide element arranged on the support structure, and wherein the guide element is arranged to contact the plant bed and/or the contents of the plant bed.

According to another aspect there is provided a cutting apparatus support comprising:
a support structure arranged to support a plant cutting apparatus above a plant bed;
at least one guide element arranged on the support structure, and wherein the guide element is arranged to contact the plant bed and/or the contents of the plant bed; and
a movement arrangement configured to allow the support structure to be moved relative to the plant bed.

The guide element may comprise a guiderail.

The guiderail may comprise a planar surface arranged to contact the plant bed and/or the contents of the plant bed.

A first portion of the guiderail may be arranged to contact the plant bed and/or the contents of the plant bed and a second portion of the guiderail may extend in a direction away from the plant bed.

The second portion may be provided on a forward and/or rearward end of the guiderail.

The guide element may comprise a plurality of guide elements.

The plurality of guide elements may comprise a first guide element arranged on a first side of the support structure so as to extend along a first side of the plant bed, and a second guide element arranged on a second side of the support structure so as to extend along a second side of the plant bed.

The first guide element and second guide element may extend in a parallel direction.

The plant cutting apparatus may comprise a lawnmower.

The movement arrangement may comprise a plurality of wheels.

The support structure may comprise a translation mechanism configured to allow the cutting apparatus to be moved relative to the support structure.

The translation mechanism may be configured to allow the cutting apparatus to be moved vertically with respect to the support structure.

The translation mechanism may be configured to allow the cutting apparatus to be moved laterally with respect to the support structure.

The support structure comprises a first side portion, a second side portion, and a connecting portion connecting the first side portion and second side portion.

Where a mount is provided, the mount may be arranged to mount the cutting apparatus to the connecting portion.

The first side portion and second side portion may be spaced apart by at least 1 m, e.g. at least 1.5 m.

The movement arrangement may be provided on each of the first side portion and second side portion.

The support structure may be at least partially formed from tubular support elements.

The support structure may comprise a handle, e.g. on an upper portion thereof.

According to another aspect there is provided a plant cutting system comprising:
a cutting apparatus support according to any of the embodiments described above; and
a plant cutting apparatus mounted to the cutting apparatus support.

The plant cutting apparatus may be mounted to the mount, where provided, or otherwise to the support structure.

### BRIEF DESCRIPTION OF THE DRAWINGS

Embodiments of the invention will now be described, by way of example only, with reference to the accompanying drawings, in which:

FIG. 1 shows a perspective view of a plant cutting system comprising a plant cutting apparatus mounted to a cutting apparatus support;

FIG. 2 shows an exploded view of the plant cutting system shown in FIG. 1;

FIG. 3 shows the plant cutting system shown in FIG. 1 in situ above a plant bed containing a plant to be cut; and

FIG. 4 shows a side view of the plant cutting system in situ above a plant bed containing a plant to be cut.

### DETAILED DESCRIPTION

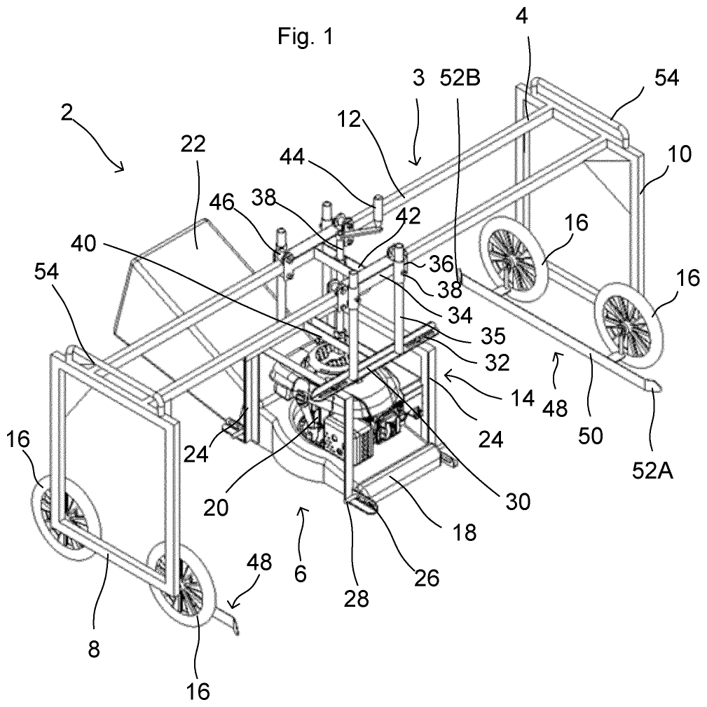

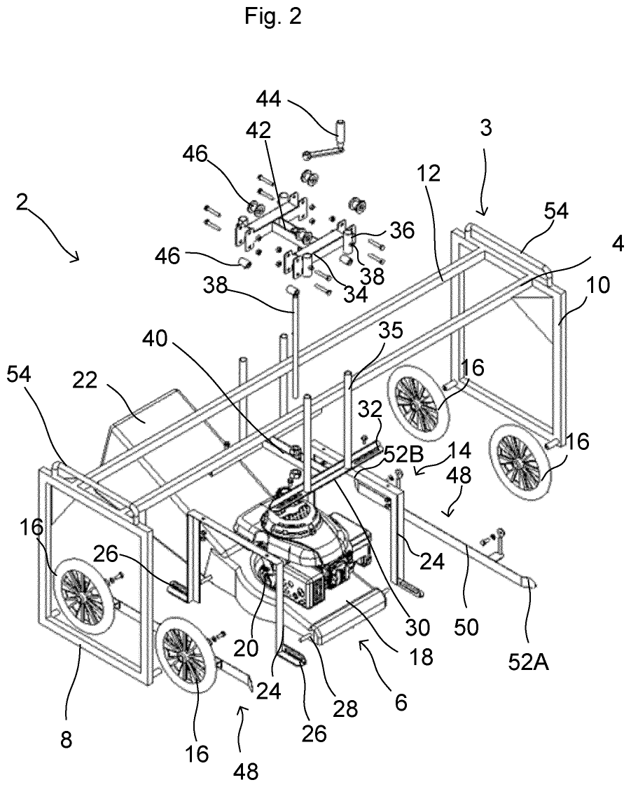

FIG. 1 shows a perspective view of an example of a plant cutting system 2 and FIG. 2 shows an exploded view of the plant cutting system 2. The plant cutting system 2 will now be described with reference to FIGS. 1 and 2. The plant cutting system 2 comprises a cutting apparatus support 3 comprising a support structure 4 to which a plant cutting apparatus 6 is mounted. The plant cutting apparatus 6 is in the form of a lawnmower, although any other plant cutting apparatus that is capable of cutting a plant may be mounted to the support structure 4.

The support structure 4 may comprise a first side portion 8, a second side portion 10 and a connecting portion 12 extending therebetween. However, it will be appreciated that the support structure 4 may have any suitable arrangement that is capable of supporting the plant cutting apparatus 6. As depicted, a mount 14, for mounting the plant cutting apparatus 6, may be attached to the connecting portion 12. However, the cutting apparatus 6 may be mounted to the support structure 4 by any other suitable means. A movement arrangement, which may comprise a plurality of wheels 16, is provided. In the example depicted, the plurality of wheels 16 are attached to each of the first and second side portions 10, 12. The wheels 16 may allow the support structure 4 to be moved, in use, relative to a plant bed. Whilst the example depicted comprises four wheels 16, any number of wheels may be provided. Further, whilst the depicted movement arrangement comprises a plurality of wheels 16, it will be appreciated that the movement arrangement may comprise any other suitable means for allowing movement of the support structure 4. For example, the movement arrangement may comprise at least one track, e.g. in the form of a continuous track, arranged to allow movement of the support structure 4.

In the example depicted, the plant cutting apparatus 6 is in the form of a lawnmower and comprises a main body 18 to which a motor 20 may be mounted. The motor 20 may be an electric motor or comprise an internal combustion engine, as depicted. A cutting element (not visible on this Figure), e.g. in the form of a cutting blade, may be arranged on the underside of the body 18 so as to be capable of cutting a plant beneath the plant cutting apparatus 6. The cutting element may, for example, be driven to rotate by the motor 20. Any suitable cutting element may be used. The plant cutting apparatus 6 may comprise a collection basket 22 arranged to collect the plant material cut by the plant cutting apparatus 6. The plant cutting apparatus 6 may be arranged to direct cut plant material towards the collection basket 22, thereby collecting plant material therein. Collection of the cut plant material may advantageously prevent the cut plant material from being deposited back onto the plants within the plant bed, which may otherwise impact their growth.

The plant cutting apparatus 6 may be mounted to the support structure 4 by the mount 14. As depicted, the mount 14 may comprise first and second mounting brackets 24. The mounting brackets 24 may extend vertically either side of the cutting apparatus 6. Each of the first and second mounting brackets 24 comprises forward and rearward elongate apertures 26 shaped to receive mounting elements 28 extending away from the body 18 of the plant cutting apparatus 6. The elongate apertures 26 provide mounting points for mounting the cutting apparatus 6. Each of the mounting elements 28, of the cutting apparatus 6, may comprise an axle which would otherwise mount a wheel directly to the plant cutting apparatus 6. Accordingly, the plant cutting apparatus 6 may be adapted for use with the cutting apparatus support 3 by removal of any wheels before being mounted to the mounting brackets 24 by engagement of the mounting elements 28 in the elongate apertures 26. Of course, it may be possible for any wheels on the plant cutting apparatus 6 to remain in place when the plant cutting apparatus 6 is mounted to the mount 14. The mounting brackets 24 each comprise forward and rearward elongate apertures 26, and thereby the two mounting brackets 24 provide four mounting points to receive mounting elements 28 on the plant cutting apparatus 6. The mounting brackets 24 may comprise any number of elongate apertures. Similarly, the mounting brackets 24 may comprise any other suitable mounting arrangement which is capable of mounting a different sized plant cutting apparatus.

The elongate apertures 26 may advantageously allow different plant cutting apparatus each with a different separation between the front and rear mounting elements 28 to be mounted to the mount 14. The elongate aperture 26 may advantageously allow the mounting element 28 to be supported at a range of positions along the elongate aperture 26 thereby allowing a plurality of different mounting apparatus 6 to be mounted to the mount 14. Accordingly, the elongate apertures 26 may provide at least two mounting configurations for interchangeably mounting at least two different sized plant cutting apparatus 6. The elongate apertures 26 may be configured to allow the mounting element 28 to be secured at a continuum of positions therein, or at a discrete set of positions therein. The mounting element 28 may be fixedly secured in position within the elongate aperture 26. For example, the mounting element 28 may be fixed in position by a threaded nut which engages with an external thread provided on the mounting element 28. Of course, any other suitable fixing arrangement may be utilised.

The elongate apertures 28 may be replaced with any other arrangement that is capable of receiving a mounting element 26 at a plurality of positions therein. For example, the mounting brackets 24 may instead comprise a plurality of spaced holes for receiving the mounting element 28. The plurality of holes may be spaced so as to provide a set of different mounting points for different sized cutting apparatus.

The mounting brackets 24 may be coupled to horizontal supports 30. The horizontal supports each comprise an elongate aperture 32. The mounting brackets 24 may be secured to the horizontal supports 30 by a bolt through the elongate aperture 32 which may be secured in place with a corresponding nut. The nut may be a captive nut held within the mounting brackets 24, or the bolt may pass through the mounting brackets 24 and a nut may be secured on an outside of the mounting bracket 24. Any other suitable means of securing the horizontal supports 30 to the mounting brackets 24 may be used. The separation of the mounting brackets 24 may be adjusted by appropriately positioning the mounting brackets 24 relative to the horizontal supports 30, and thus the elongate aperture 32 thereon. The mounting brackets 24 may then be secured in position, for example using the bolts and corresponding nuts. The range of possible separations of the mounting brackets 24 may be defined by the size of the elongate apertures 32. As will be appreciated, adjusting the spacing of the brackets 24 may act to adjust the lateral spacing of the elongate apertures 26 on the mounting brackets 24, and thus act to adjust the lateral spacing of the mounting points. This may provide at least two mounting configurations such that different sized plant cutting apparatus can be attached to the mount 14. This particular arrangement may advantageously allow different plant cutting apparatus having different widths to be attached to mount 14.

The ability to mount different sized plant cutting apparatus 6 may make the cutting apparatus support 4 more versatile and suitable for use with a range of different plant cutting apparatus.

The horizontal supports 32 may be mounted via at least one, e.g. a plurality of, vertical supports 35 which may be connected to horizontal runners 34 which rest on the connection portion 12. The vertical supports 35 may pass through sleeves 36 which are fixedly positioned on the horizontal runners 34. A locking nut 38 may be provided on some or all of the sleeves 36 and may be used to hold the respective vertical support 35 in a fixed position with respect to the sleeve 36. Holding the vertical support 35 in a fixed positon may secure the mount 14 in a fixed vertical position relative to the rest of the support structure 4.

The support structure 4 may comprise a translation mechanism which allows the plant cutting apparatus 6 to be moved relative to the support structure 4. The translation mechanism may comprise a height adjustment rod 38 arranged to allow the plant cutting apparatus 6 to be moved vertically relative to the support structure 4. The height adjustment rod 38 is connected to a first cross member 40 which connects the horizontal supports 32 and extends through a second cross member 44 which extends between the horizontal runners 34. Whilst not visible in this Figure, a threaded nut may be fixed inside the second cross member 42, and the height adjustment rod 38 may pass through the threaded nut. At least a portion of the height adjustment rod 38 may be threaded and engage with the threaded nut. A handle 44 may be provided for rotating the height adjustment rod 38. As will be appreciated by those skilled in the art, when the handle 44 is rotated, this will cause rotation of the height adjustment rod 38. Due to the engagement of the height adjustment rod 38 with the threaded nut, this will cause the height adjustment rod to move axially upwards or downwards, depending on the direction of rotation. This will cause the mount 14 to translate upwards or downwards and thereby adjust the vertical height of the plant cutting apparatus 6 mounted thereto. In addition, or instead of the handle 44, a motor may be provided to rotate the height adjustment rod 38. Whilst an example is depicted and described which utilises a height adjustment rod 38, any other suitable arrangement may be used for adjusting the vertical height of the plant cutting apparatus 6.

The horizontal runners 34 are configured to slide relative to the connection portion 12. The horizontal runners 34 may therefore provide a translation mechanism which allows the plant cutting apparatus 6 to be moved laterally with respect to the support structure 4. The horizontal runners 34 may comprise rollers 46 which are arranged to engage the connection portion 12. The rollers 46 may facilitate the translation of the horizontal runners 34 relative to the connection portion 12 with reduced friction, thereby making the mount 14 easier to move.

The cutting support structure 4 may further comprise at least one guide element 48. The guide element 48 may be in the form of a guiderail as depicted in FIG. 1. The cutting support structure 4 may comprise a guide element 48 on each side of the cutting support structure 4, for example on each of the side portions 8, 10, as depicted. As will be appreciated by those skilled in the art, the support structure 4 may be arranged over a plant bed such that one of the guide elements 48 extends along a first side of the plant bed and the other of the guide elements 48 extends along a second side of the plant bed. As depicted, the guide elements 48 may extend substantially parallel to one another.

Each of the guide elements 48 may comprise a first portion 50 which is arranged to contact the plant bed and/or the contents of the plant bed. Each of the guide elements 48 may further comprise a second portion. In the embodiment depicted, the guide elements each comprise a forward second portion 52A and a rearward second portion 52B. The forward and rearward second portions 52A, 52B are angled with respect to the first portion 50 and may extend in a direction away from the plant bed, in use. The forward and rearward second portions 52A, 52B may act to guide any plant material which extends away from the plant bed in a direction towards the plant cutting apparatus 6. This may help to ensure that all of the plant within the plant bed is cut during use of the plant cutting system. The guide elements 48 may also contact the plant bed as the support structure 4 is moved relative to the plant bed, and may thus act to guide the support structure 4 along the plant bed. This may make use of the system 2 easier as an operator may not, necessarily, have to be concerned with appropriate guiding of the support apparatus 3.

As depicted, each of the guide elements 48 may be substantially planar and the first portion 50 may be substantially planar. This may increase the contact between the first portion 50 and the plant bed, thereby improving the guiding performed by the guide element 48.

The cutting apparatus support 4 may comprise at least one handle 54. In the embodiment depicted, a handle 54 is provided on each of the first and second side portions 8, 10. The handle 54 may be used to move, e.g. by pushing or pulling, the cutting apparatus support 4 relative to a plant bed.

Where appropriate, components of the cutting support structure 4 may be formed from tubular support elements. This may advantageously reduce the weight of the cutting support structure 4 which may make the cutting support structure 4 easier to manoeuvre. This may make it easier to move the cutting support structure 4 along and between plant beds.

Use of the plant cutting system 2 will now be described with reference to FIGS. 1 and 2. The plant cutting apparatus 6 may first be mounted to the mount 14 as described below. At least one, e.g. both, of the mounting brackets 24 may be separated from the horizontal supports 30. The plant cutting apparatus 6 may then be attached to the mounting brackets 24. The mounting elements 28, on the plant cutting apparatus 6, may be positioned in the elongate apertures 26. As discussed previously, the elongate apertures 26 may allow for plant cutting apparatuses with different separations between the mounting elements 28 to be mounted to the mounting brackets 24. The mounting elements 28 may be fixed in position within the elongate apertures 26. In some cases, fixing of the mounting elements 28 within the elongate apertures 26 may not be necessary as the mounting brackets 24 themselves may be held such that their separation is fixed, which may act to prevent the the mounting elements 28 from demounting from within the elongate apertures 26.

One or both of the mounting brackets 24 may then be attached to the horizontal supports 30. As will be appreciated, the elongate apertures 32 on the horizontal supports 30 will allow for a range of separations of the mounting brackets 24 and thereby allow different plant cutting apparatus 6 having different widths to be mounted to the mount 14. The mounting brackets 24 may be secured to the horizontal supports by bolts and corresponding nuts, or any other appropriate fixing element. Of course, the plant cutting apparatus 6 may be mounted to the mount 14 in any suitable manner, and it may not be necessary to separate the mounting brackets 24 in order to mount the plant cutting apparatus 6.

With the plant cutting apparatus 6 attached to the mount 14, the vertical position of the mount 14, and thus the plant cutting apparatus 6, may be adjusted to a desired height. In order to adjust the height of the mount 14, any nuts 38 provided on the sleeves 36 may first be released so as to allow movement of the vertical supports 35 relative to the sleeves 36. The handle 44 may then be rotated so as to rotate the height adjustment rod 38 so as to raise or lower the mount 14. Once in the desired position, the mount 14 may be fixed in position, for example by tightening the nuts 38 on the sleeves 36. The support structure 4 may comprise alternative means for holding the mount 14 in a fixed vertical position. For example, a rotation prevention mechanism may be provided which is arranged to prevent rotation of the height adjustment rod 38, which may thereby hold the mount 14 in a fixed vertical position. The rotation prevention mechanism may be selectively engaged such that the adjustment rod 38 can be used to adjust the height of the mount 14 when desired.

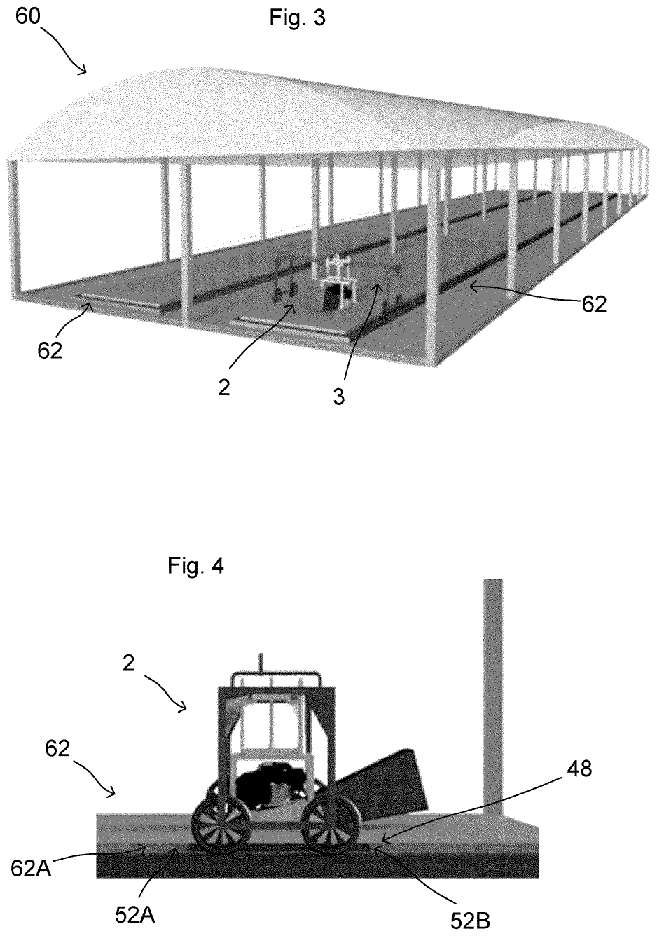

The plant cutting system 2 may then be positioned over a plant bed. FIG. 3 depicts the plant cutting system 2, shown in FIGS. 1 and 2, in use when positioned over a plant bed. As depicted in FIG. 3, a facility 60 may comprise a plurality of plant beds 62. The plant cutting system 2 may be positioned over a plant bed 62. As a result, the plants within the plant beds 62 may be cut in situ, thereby potentially removing the need to remove the plants from the plant bed which may reduce the amount of labour required. The plant cutting apparatus 6 may be translated relative to the plant bed 62 by pushing the cutting apparatus support 3 along the plant bed 62. This may be performed with the plant cutting apparatus 6 at a fixed vertical height and at a first lateral position relative to the support structure. After the cutting apparatus support 3 with the plant cutting apparatus mounted thereto has been translated relative to the plant bed 62, the lateral position of the plant cutting apparatus relative to the support structure 4 may be adjusted. As discussed previously. The lateral position may be adjusted by sliding the mount 14 laterally along the connection portion 12 on the horizontal runners 34. Once the lateral position has been adjusted and the cutting apparatus 6 is in a desired position, the cutting apparatus support 3 may again be translated relative to the plant bed 66. This process may be repeated as many times as is necessary in order to cut the required plants within the plant bed 62.

As will be appreciated, the cutting apparatus support 3 may advantageously allow a plant cutting apparatus 6, e.g. a lawnmower (as depicted), to be utilised to cut plants other than those that was initially designed for. This may provide a convenient and cost effective means for providing a plant cutting system 2. The cutting apparatus support 3, together with the plant cutting apparatus 6 mounted thereon, may allow the plants within the plant bed 62 to be cut in situ. This may avoid having to remove the plants from the plant bed, thereby potentially improving the efficiency of the process of plant cutting.

The movement means, depicted in the form of wheels 16, may allow the support structure 4 to be translated relative to a plant bed. When the mount 14 is held in a fixed vertical position, e.g. by fixing the vertical height by tightening of the nuts 38, the cutting apparatus 6 may be translated relative to a plant bed at a fixed height thereby achieving uniform cutting, e.g. clipping, of the plant within the plant bed.

FIG. 4 shows a side view of the plant cutting system 2 in situ above the plant bed 62. As mentioned previously, when the plant cutting system 2 is translated relative to the plant bed 62, the guide elements 48 may engage with a side 62A of the plant beds 62 and thereby guide the cutting apparatus support 3 along the plant beds 62. Additionally, the forward and rearward portions 52A, 52B of the guide elements 48 may act to direct any plant material which extends outwards, and away from the plant beds 62, back towards the plant beds 62 and into the path of the plant cutting apparatus 6. This may help to ensure that all of the plant material within the plant bed 62 is cut by the plant cutting apparatus 6.

The plant beds 62 may contain any appropriate plant which requires cutting. For example, the plant beds 62 may comprise tobacco seedlings.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A cutting apparatus support comprising:
a mount arranged to mount a plant cutting apparatus, wherein the mount comprises at least two mounting configurations so as to interchangeably mount at least two different sized plant cutting apparatus;
a support structure arranged to support the mount above a plant bed; and
a movement arrangement configured to allow the support structure to be moved relative to the plant bed.

2. The cutting apparatus support of claim 1, wherein the mount is adjustable to provide the at least two mounting configurations.

3. The cutting apparatus support of claim 2, wherein the mount comprises a plurality of mounting points for mounting the plant cutting apparatus, and wherein a spacing between the plurality of mounting points is adjustable so as to provide the at least two mounting configurations.

4. The cutting apparatus support of claim 1, wherein the mount comprises a plurality of mounting points for mounting the plant cutting apparatus, and wherein each of the plurality of mounting points comprise at least one aperture shaped to receive a mounting element extending from the plant cutting apparatus.

5. The cutting apparatus support of claim 4, wherein the plant cutting apparatus is a lawnmower, and wherein the mounting element is an axle of the lawnmower.

6. The cutting apparatus support of claim 1, wherein the at least one aperture comprises an elongate aperture configured to support the mounting element at a plurality of positions along a length of the elongate aperture.

7. The cutting apparatus support of claim 1, comprising at least one guide element arranged on the support structure, and wherein the at least one guide element is arranged to contact the plant bed and/or contents of the plant bed.

8. A cutting apparatus support comprising:
a support structure arranged to support a plant cutting apparatus above a plant bed;
at least one guide element arranged on the support structure, and wherein the at least one guide element is arranged to contact the plant bed and/or contents of the plant bed; and
a movement arrangement configured to allow the support structure to be moved relative to the plant bed.

9. The cutting apparatus support of claim 8, wherein the at least one guide element comprises a guiderail.

10. The cutting apparatus support of claim 9, wherein the guiderail comprises a planar surface arranged to contact the plant bed and/or the contents of the plant bed.

11. The cutting apparatus support of 9, wherein a first portion of the guiderail is arranged to contact the plant bed and/or the contents of the plant bed and wherein a second portion of the guiderail extends in a direction away from the plant bed.

12. (canceled)

13. The cutting apparatus support of claim 8, wherein the at least one guide element comprises a plurality of guide elements.

14. The cutting apparatus support of claim 13, wherein the plurality of guide elements comprise a first guide element arranged on a first side of the support structure so as to extend along a first side of the plant bed, and a second guide element arranged on a second side of the support structure so as to extend along a second side of the plant bed.

15. The cutting apparatus support of claim 14, wherein the first guide element and the second guide element extend in a parallel direction.

16. (canceled)

17. (canceled)

18. The cutting apparatus support of claim 1, wherein the support structure comprises a translation mechanism configured to allow the plant cutting apparatus to be moved relative to the support structure.

19. The cutting apparatus support of claim 18, wherein the translation mechanism is configured to allow the plant cutting apparatus to be moved vertically with respect to the support structure.

20. The cutting apparatus support of claim 18, wherein the translation mechanism is configured to allow the plant cutting apparatus to be moved laterally with respect to the support structure.

21. The cutting apparatus support of claim 1, wherein the support structure comprises a first side portion, a second side portion, and a connecting portion connecting the first side portion and second side portion,

22. (canceled)

23. The cutting apparatus support of claim 21, wherein the movement arrangement is provided on each of the first side portion and the second side portion.

24. (canceled)

25. A plant cutting system comprising:
the cutting apparatus support of claim 1; and
a plant cutting apparatus mounted to the cutting apparatus support.
